(19) United States
(12) Patent Application Publication
(10) Pub. No.: US 2008/0053450 A1
(43) Pub. Date: Mar. 6, 2008

(54) Patient interface assembly for a breathing assistance system

(75) Inventors: Mark Jacobus Van Kerkwyk, Fremont, CA (US); Mahmoud Janbakhsh, San Ramon, CA (US); Himanshu J. Chokshi, Fremont, CA (US)

Correspondence Address: Covidien;IP Counsel, Respiratory & Monitoring Solutions, 60 Middleton Avenue, North Haven, CT, 06473, US

(73) Assignee: Nellcor Puritan Bennett Incorporated

(21) Appl. No.: 11/469,260

(22) Filed: Aug. 31, 2006

(51) Int. Cl. A62B 18/02; A62B 18/08

(52) U.S. Cl. 128/206.24; 128/205.25

(57) ABSTRACT

A patient interface for a breathing assistance system may include a facial seal releasably coupled to a seal support. The seal support may include an opening and a first connection portion extending at least substantially around the opening. The facial seal may include a first side having a first seal opening and configured to provide a seal against a patient's face, a second side having a second seal opening, and a passageway extending between the first and second seal openings for delivering breathing gas to the patient. The facial seal may further include a second connection portion extending at least substantially around the second seal opening. The second connection portion may be deformed to mate with the first connection portion to releasably couple the facial seal to the seal support and to form a seal between the facial seal and the seal support.

### TECHNICAL FIELD

The present disclosure relates generally to the field of breathing assistance systems, e.g., a patient interface assembly for a breathing assistance system.

### BACKGROUND

In recent years, continuous positive airway pressure (CPAP) therapy has become a common prescription for individuals suffering from sleep apnea and/or other breathing ailments. Such therapy may involve placement of a nose or face mask on the subject during sleeping, while positive pressure air is continuously delivered to the subject through the mask. The positive pressure air may be delivered to the patient's upper airway to prevent the upper airway tissues from collapsing during sleep, thus reducing the occurrence and/or severity of sleep apnea.

### SUMMARY

In accordance with one embodiment of the present disclosure, a patient interface for a breathing assistance system includes a facial seal releasably coupled to a seal support. The seal support may include a seal support opening and a first connection portion extending at least substantially around the seal support opening. The facial seal may include a first side having a first seal opening and configured to provide a seal against a patient's face, a second side having a second seal opening, and a passageway extending between the first seal opening and the second seal opening for delivering breathing gas to the patient. The facial seal may further include a second connection portion extending at least substantially around the second seal opening. The second connection portion may be formed from one or more deformable materials such that the second connection portion may be deformed to mate with the first connection portion to releasably couple the facial seal to the seal support and to form a seal between the facial seal and the seal support.

In accordance with another embodiment of the present disclosure, a facial seal for a breathing assistance system may include a first side having a first seal opening, the first side being configured to provide a seal against a patient's face, a second side having a second seal opening, and a passageway extending between the first seal opening and the second seal opening for delivering breathing gas to the patient. The facial seal may further include a first connection portion extending at least substantially around the second seal opening and configured to be releasably coupled to a seal support having a second connection portion. The first connection portion may be formed from one or more deformable materials such that the first connection portion may be deformed to mate with the second connection portion of the seal support to releasably couple the facial seal to the seal support and to form a seal between the facial seal and the seal support.

In accordance with yet another embodiment of the present disclosure, a mask apparatus for delivering gas to a patient may include a gas delivery conduit for delivering breathing gas toward the patient, a seal support coupled to the gas delivery conduit, a facial seal releasably couplable to the seal support, and headgear for securing the facial seal against the patient's face. The seal support may include a seal support opening and a first connection portion extending at least substantially around the seal support opening. The facial seal may include a first side having a first seal opening and configured to provide a seal against a patient's face, a second side having a second seal opening, and a passageway extending between the first seal opening and the second seal opening for delivering the breathing gas to the patient. The facial seal may further include a second connection portion extending at least substantially around the second seal opening. The second connection portion may be formed from one or more deformable materials such that the second connection portion may be deformed to mate with the first connection portion to releasably couple the facial seal to the seal support and to form a seal between the facial seal and the seal support.

In accordance with yet another embodiment of the present disclosure, a patient interface for a breathing assistance system may include facial sealing means releasably coupled to seal supporting means. The seal supporting means may include a seal supporting means opening and a first connection portion extending at least substantially around the seal supporting means opening. The facial sealing means may include a first side having a first seal opening and configured to provide a seal against a patient's face, a second side having a second seal opening, and a passageway extending between the first seal opening and the second seal opening for delivering breathing gas to a patient. The facial sealing means may further include a second connection portion extending at least substantially around the second seal opening. The second connection portion may be formed from one or more deformable materials such that the second connection portion may be deformed to mate with the first connection portion to releasably couple the facial sealing means to the seal supporting means and to form a seal between the facial sealing means and the seal supporting means.

In accordance with yet another embodiment of the present disclosure, a method for assembling a patient interface for a breathing assistance system is provided. The method includes holding a facial seal including a first side having a first seal opening and configured to provide a seal against a patient's face, a second side having a second seal opening, and a deformable first connection portion extending at least substantially around the second seal opening. The method further includes mating the facial seal with a seal support having a seal support opening and second connection portion extending at least substantially around the seal support opening such that the first connection portion is deformed to mate with the second connection portion to releasably couple the facial seal to the seal support and to form a seal between the facial seal and the seal support.

### BRIEF DESCRIPTION OF THE DRAWINGS

FIG. 1 illustrates an example breathing assistance system for providing breathing assistance to a patient, according to one embodiment of the disclosure;

FIGS. 2A-2B illustrate an example patient interface assembly of a mask apparatus for use in the breathing assistance system of FIG. 1, according to one embodiment;

FIGS. 3A-3B illustrate another example patient interface assembly of a mask apparatus for use in the breathing assistance system of FIG. 1, according to another embodiment;

FIGS. 4A-4B illustrate another example patient interface assembly of a mask apparatus for use in the breathing assistance system of FIG. 1, according to another embodiment;

FIGS. 5A-5B illustrate another example patient interface assembly of a mask apparatus for use in the breathing assistance system of FIG. 1, according to another embodiment; and

FIG. 6 illustrates a method for coupling and uncoupling a facial seal and a seal support of a patient interface assembly, according to certain embodiments.

### DETAILED DESCRIPTION OF THE DRAWING

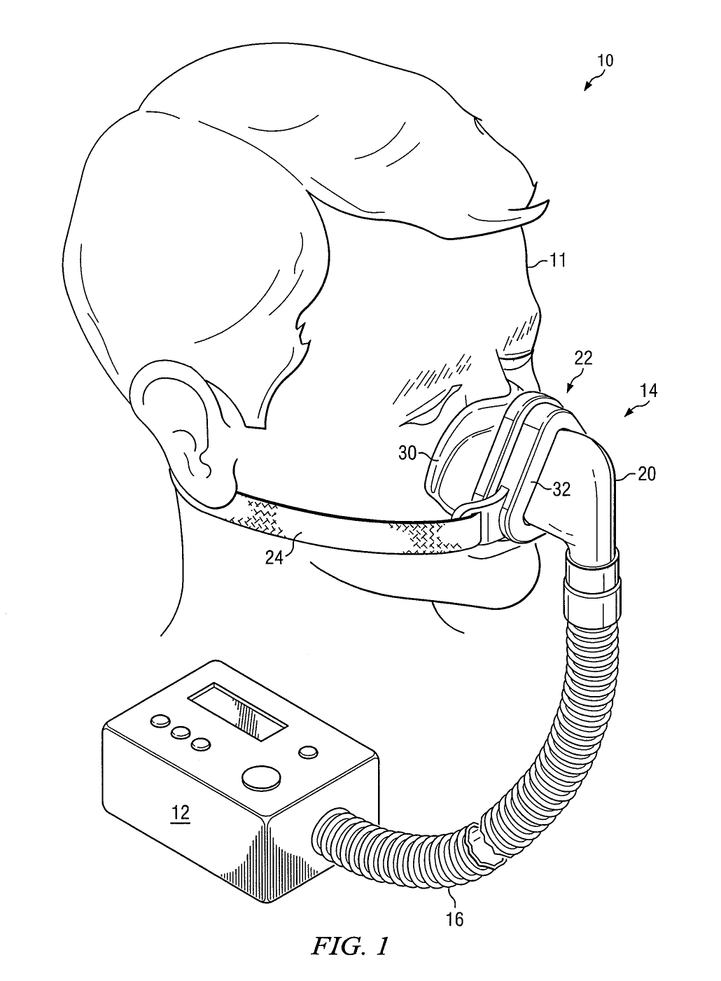

Selected embodiments of the disclosure may be understood by reference, in part, to FIGS. 1-6, wherein like numbers refer to same and like parts. The present disclosure relates generally to patient interfaces for breathing assistance systems (e.g., ventilators, CPAP devices, or BiPAP devices). In some embodiments, a patient interface assembly includes a facial seal releasably coupled to a seal support. The seal support may define an opening and may include a support member connection portion extending at least substantially around the opening. The facial seal may include a first side defining a first seal opening and configured to provide a seal against a patient's face, a second side having a second seal opening, and a passageway extending between the first and second seal openings for delivering breathing gas to the patient. The facial seal may further include a facial seal connection portion extending at least substantially around the second seal opening. The facial seal connection portion may be deformed to mate with the support member connection portion to releasably couple the facial seal to the seal support and to form a seal between the facial seal and the seal support. In some embodiments, the facial seal and the seal support may be repeatedly coupled and uncoupled by hand.

In some embodiments, the facial seal connection portion includes one or more deformable flanges that define a slot, and the support member connection portion includes a protrusion that may be received into the slot to couple the facial seal to the seal support. In other embodiments, the support member connection portion includes one or more flanges that define a slot, and the support member includes a deformable protrusion that may be inserted into the slot to couple the facial seal to the seal support.

The protrusion, whether defined by the facial seal connection portion or the support member connection portion, may have any suitable shape and/or cross-section. For example, the protrusion may have a rounded cross-section or an L-shaped cross-section. In some embodiments, one of the support member connection portion and the facial seal connection portion comprises a protrusion having a substantially L-shaped cross-section, and the other one of the support member connection portion and the facial seal connection portion defines a slot configured to receive the L-shaped protrusion.

FIG. 1 illustrates an example breathing assistance system 10, according to one embodiment of the disclosure. Breathing assistance system 10 may be generally configured to provide breathing assistance (e.g., providing ventilation and/or treating an apnea or other breathing condition) to a patient 11. Breathing assistance system 10 may include a gas delivery system 12, a mask apparatus 14, and a connection system 16 between gas delivery system 12 and mask apparatus 14.

Gas delivery system 12 may include any device or devices configured to generate, supply, and/or deliver gas (e.g., pressurized air) toward patient 11 via mask apparatus 14. For example, gas delivery system 12 may comprise a device capable of generating pressurized air (e.g., a ventilator, CPAP system, or BiPAP system), a wall outlet through which pressurized air may be supplied (e.g., in a hospital or clinic), one or more tanks of compressed gas, a compressor, or any other suitable source of pressurized or non-pressurized gas. As used herein, the term “gas” may refer to any one or more gases and/or vaporized substances suitable to be delivered to and/or from a patient via one or more breathing orifices (e.g., the nose and/or mouth), such as air, nitrogen, oxygen, any other component of air, CO₂, vaporized water, vaporized medicines, and/or any combination of two or more of the above, for example. The term “patient” may refer to any person or animal that may receive breathing assistance from system 10, regardless of the medical status, official patient status, physical location, or any other characteristic of the person. Thus, for example, patients may include persons under official medical care (e.g., hospital patients), persons not under official medical care, persons receiving care at a medical care facility, persons receiving home care, etc.

Mask apparatus 14 may be generally configured to deliver gas supplied by gas delivery system 12 to patient 11 and/or to remove exhaust gas away from patient 11. Mask apparatus 14 may include one or more gas delivery conduits 20, a patient interface assembly 22 communicatively coupled to at least one conduit 20, and/or headgear 24 for securing mask apparatus 14 to the patient's head, which may include securing patient interface apparatus 22 against the patient's face. Mask apparatus 14 may include any other components, e.g., a forehead support system, one or more adjustment systems, and/or a gas exhaust system, each of which may be separate from, or partially or fully integrated with, one or more other components of mask apparatus 14.

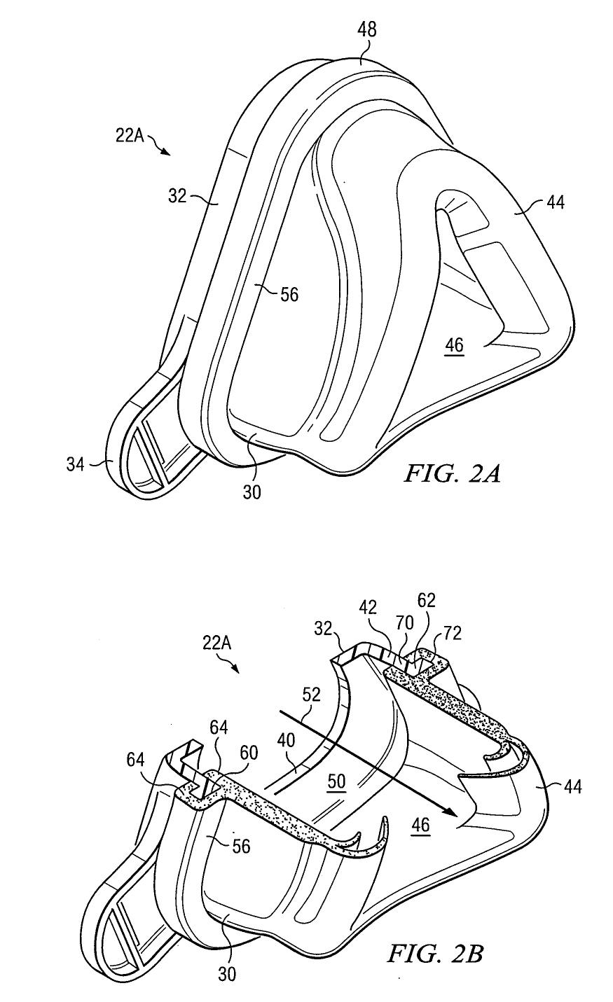

As discussed in greater detail with reference to FIGS. 2-6, patient interface assembly 22 may include a facial seal 30 releasably coupled to a seal support 32. As discussed below, seal support 32 may define an opening and may include a support member connection portion extending at least substantially around the opening, and facial seal 30 may include a facial seal connection portion that may be deformed to mate with the support member connection portion to releasably and sealably couple facial seal 30 to seal support 32.

Facial seal 30 may be configured to provide a seal around at least one breathing passageway of patient 11, e.g., the patient's nose and/or mouth. In some embodiments, facial seal 30 may comprise a nasal interface that fits around the patient's nose. In other embodiments, facial seal 30 may comprise a mouth interface that fits around the patient's mouth. In other embodiments, facial seal 30 may comprise a full face interface that fits around the patient's nose and mouth. Facial seal 30 may be a single, integrated component, or may include multiple components coupled together.

Seal support 32 may comprise any component of mask apparatus 14, such as a mask shell, a support member, a frame member, a base member, a connection member, an arm member, or a conduit, for example. In the example embodiments shown in FIGS. 2-5, seal support 32 comprises a mask shell or frame that includes head strap connection portions 34 for receiving head straps for securing facial seal 30 against the patient's face. Seal support 32 may be a single, integrated component, or may include multiple components coupled together.

Mask apparatus 14 may be coupled to gas delivery system 12 by connection system 16. Connection system 16 may include any one or more conduits (e.g., one or more flexible hoses) for communicating gas from gas delivery system 12 to mask apparatus 14. In some embodiments, connection system 16 may be coupled to one or more gas delivery conduits 20 of mask apparatus 14. When assembled, breathing assistance system 10 may define one or more gas delivery passageways from gas delivery system 12 to patient 11, passing through connection system 16, gas delivery conduit(s) 20, patient interface assembly 22, and/or one or more other components of system 10. Such passageways may be used to deliver gas from gas delivery system 12 to patient 11. In addition, in some embodiments, gas delivery conduits 20 and/or connection system 16 may include or define one or more passageways for communicating exhaled gas away from patient 11.

FIGS. 2A-2B illustrate an example patient interface assembly 22A of a mask apparatus 14 for use in a breathing assistance system 10, according to one embodiment. In particular, FIG. 2A is a three-dimensional view of patient interface assembly 22, and FIG. 2B is a cut-away view of FIG. 2A showing a cross-section of patient interface assembly 22A.

Patient interface assembly 22A may include a facial seal 30 releasably coupled to a seal support 32. Seal support 32 may define an opening 40 and may include a support member connection portion 42 extending at least substantially around opening 40. Facial seal 30 may include a first, face interfacing side 44 defining a first seal opening 46 and configured to provide a seal against the face of patient 11, a second side 48 having a second seal opening 50, and a passageway 52 extending between first and second seal openings 46 and 50 for delivering breathing gas to patient 11. Facial seal 30 may further include a facial seal connection portion 56 extending at least substantially around second seal opening 50. Facial seal connection portion 56 may be formed proximate second side 48.

All or portions of facial seal 30 may be formed from one or more flexible or deformable materials. Face interfacing side 44 of facial seal 30 may be formed from a flexible or deformable material (e.g., deformable plastic or rubber) to provide an effective and comfortable seal against the face. In addition, facial seal connection portion 56 may be formed from a flexible or deformable material such that facial seal connection portion 56 may be deformed to mate with support member connection portion 42 to releasably couple facial seal 30 to seal support 32. In some embodiments, face interfacing side 44 and facial seal connection portion 56 are formed from the same material(s). In a particular embodiment, all of facial seal 30 is formed from the same material(s). In other embodiments, face interfacing side 44 and facial seal connection portion 56 are formed from different materials. For example, face interfacing side 44 may be formed from a first deformable material, and facial seal connection portion 56 may be formed from a second deformable material that is more or less deformable than face interfacing side 44.

In some embodiments, facial seal connection portion 56 may define a slot 60 configured to receive a protrusion 62 associated with support member connection portion 42 to couple facial seal 30 to seal support 32. Slot 60 may be defined by one or more deformable members of facial seal connection portion 56. For example, as shown in FIG. 2B, facial seal connection portion 56 may include one or more deformable flanges 64 that define slot 60. Flanges 64 may be deformed in order to receive protrusion 62 into slot 60. As used herein, a “flange 64” may include any member or portion of facial seal 30 or seal support 32 that defines or helps define a slot 60 for receiving a protrusion 62.

Protrusion 62, flanges 64, and slot 60 may have any suitable shape, cross-section, size, and/or configuration. For example, in this embodiment, protrusion 62 has an L-shaped cross-section defined by (a) a longitudinal portion 70 extending generally in a first direction that extends from second seal opening 50 to first seal opening 46, and (b) a lateral portion 72 extending outwardly and generally perpendicular from longitudinal portion 70. Slot 60 may have a generally L-shaped cross-section corresponding to that of protrusion 62, which may provide an effective seal between facial seal 30 and seal support 32.

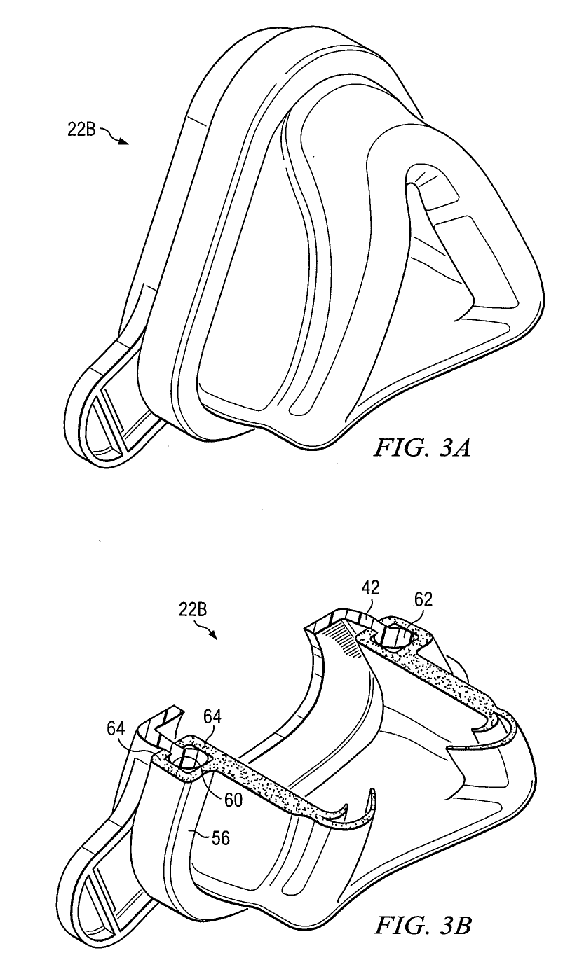

FIGS. 3A-3B illustrate another example patient interface assembly 22B of a mask apparatus 14 for use in a breathing assistance system 10, according to one embodiment. In particular, FIG. 3A is a three-dimensional view of patient interface assembly 22B, and FIG. 3B is a cut-away view of FIG. 3A showing a cross-section of patient interface assembly 22B. Patient interface assembly 22B may be generally similar to patient interface assembly 22A shown in FIGS. 2A-2B, but having different connection portions, as discussed below.

In this embodiment, facial seal connection portion 56 includes one or more deformable flanges 64 that define slot 60, which flanges 64 may be deformed in order to receive protrusion 62 into slot 60. Protrusion 62 may have a rounded (e.g., circular, elliptical, oval, or otherwise rounded) cross-section. As shown in FIG. 3B, slot 60 may have a generally square or rectangular cross-section sized to receive rounded protrusion 62, which may provide an effective seal between facial seal 30 and seal support 32. In other embodiments, slot 60 may have a rounded cross-section corresponding to the rounded cross-section of protrusion 62.

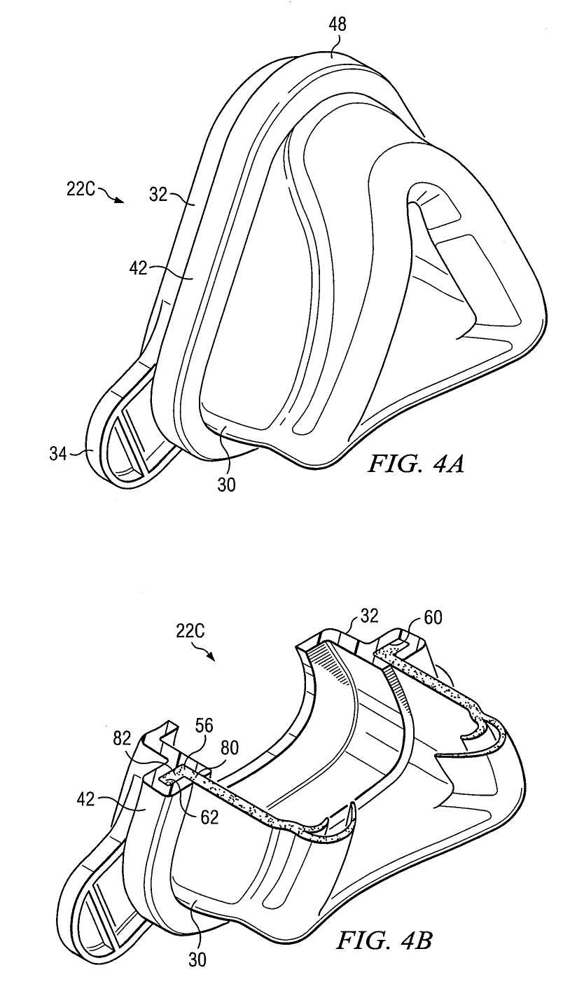

FIGS. 4A-4B illustrate another example patient interface assembly 22C of a mask apparatus 14 for use in a breathing assistance system 10, according to one embodiment. In particular, FIG. 4A is a three-dimensional view of patient interface assembly 22C, and FIG. 4B is a cut-away view of FIG. 4A showing a cross-section of patient interface assembly 22C. Patient interface assembly 22C may be generally similar to patient interface assembly 22A shown in FIGS. 2A-2B, but slot 60 and protrusion 62 are reversed, as discussed below.

In this embodiment, slot 60 is formed in support member connection portion 42, and protrusion 62 is formed in facial seal connection portion 56. Slot 60 is configured to receive protrusion 62 to releasably couple facial seal 30 to seal support 32. Protrusion 62 may be formed from one or more deformable materials such that protrusion 62 may be deformed to be inserted into slot 60.

As discussed above, protrusion 62 and slot 60 may have any suitable shape, cross-section, size, and/or configuration. For example, in this embodiment, protrusion 62 formed in facial seal connection portion 56 has an L-shaped cross-section defined by (a) a longitudinal portion 80 extending generally in a first direction that extends from second seal opening 50 to first seal opening 46, and (b) a lateral portion 82 extending outwardly and generally perpendicular from longitudinal portion 80. Slot 60 may have a generally L-shaped cross-section corresponding to that of protrusion 62, which may provide an effective seal between facial seal 30 and seal support 32.

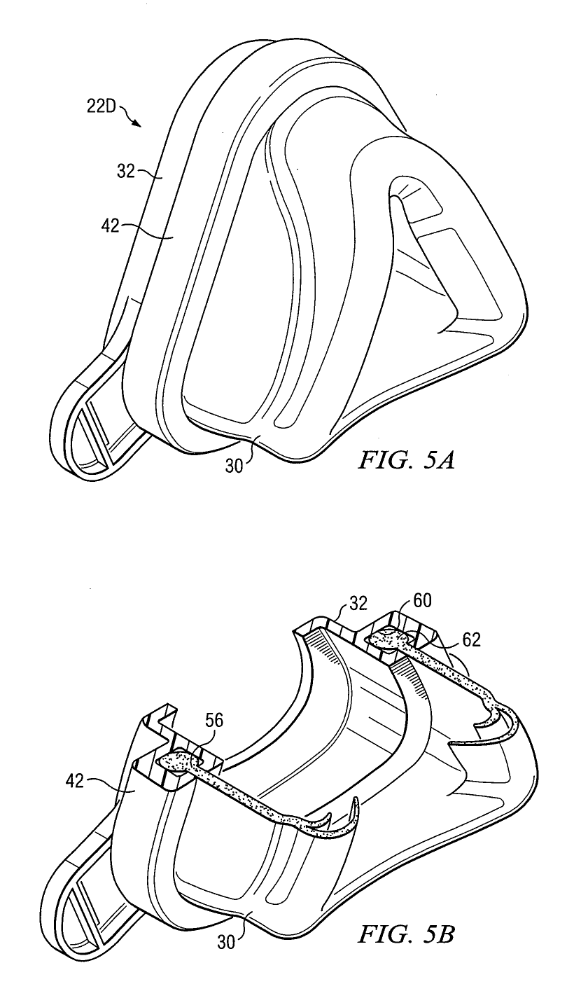

FIGS. 5A-5B illustrate another example patient interface assembly 22D of a mask apparatus 14 for use in a breathing assistance system 10, according to one embodiment. In particular, FIG. 5A is a three-dimensional view of patient interface assembly 22D, and FIG. 5B is a cut-away view of FIG. 5A showing a cross-section of patient interface assembly 22D. Patient interface assembly 22D may be generally similar to patient interface assembly 22B shown in FIGS. 3A-3B, but slot 60 and protrusion 62 are reversed, as discussed below.

In this embodiment, slot 60 is formed in support member connection portion 42, and protrusion 62 is formed in facial seal connection portion 56. Slot 60 is configured to receive protrusion 62 to releasably couple facial seal 30 to seal support 32. Protrusion 62 may be formed from one or more deformable materials such that protrusion 62 may be deformed to be inserted into slot 60.

As discussed above, protrusion 62 and slot 60 may have any suitable shape, cross-section, size, and/or configuration. For example, in this embodiment, protrusion 62 may have a rounded (e.g., circular, elliptical, oval, or otherwise rounded) cross-section. As shown in FIG. 5B, slot 60 may have a generally square or rectangular cross-section sized to receive rounded protrusion 62, which may provide an effective seal between facial seal 30 and seal support 32. In other embodiments, slot 60 may have a rounded cross-section corresponding to the rounded cross-section of protrusion 62.

In any of the embodiments discussed herein (e.g., the embodiments shown in FIGS. 2-5), support member connection portion 42 may extend at least substantially around opening 40. In some embodiments, support member connection portion 42 extends completely around opening 40. For example, as shown in FIGS. 2-5, protrusion 62 may extend completely around opening 40. In other embodiments, support member connection portion 42 may include multiple separate portions spaced around opening 40.

Similarly, facial seal connection portion 56 may extend at least substantially around second seal opening 50. In some embodiments, facial seal connection portion 56 extends completely around second seal opening 50. For example, as shown in FIGS. 2-5, slot 60 may extend completely around second seal opening 50. In other embodiments, facial seal connection portion 56 may include multiple separate portions spaced around second seal opening 50.

In addition, in other embodiments, protrusion 62, flanges 64, and slot 60 may have other shapes, cross-sections, sizes, and/or configurations. As examples only, protrusion 62 and/or slot 60 may have rectangular, square, triangular, pentagonal, hexagonal, octagonal, curved, arced, Y-shaped, V-shaped, or T-shaped cross-sections). In some embodiments (e.g., as shown in FIGS. 2B and 4B), slot 60 may have the same cross-section as protrusion 62. In other embodiments (e.g., as shown in FIGS. 3B and 5B), slot 60 may have a different cross-section than protrusion 62, which may provide gaps between slot 60 and protrusion 62 that may or may not be filled with one or more suitable filler or sealing materials.

In any of the embodiments discussed herein (e.g., the embodiments shown in FIGS. 2-5), facial seal connection portion 56 may be releasably couplable with support member connection portion 42 such that facial seal 30 and seal support 32 may be manually (e.g., by hand) and repeatably coupled and uncoupled, e.g., to allow cleaning or replacement of facial seal 30 and/or seal support 32.

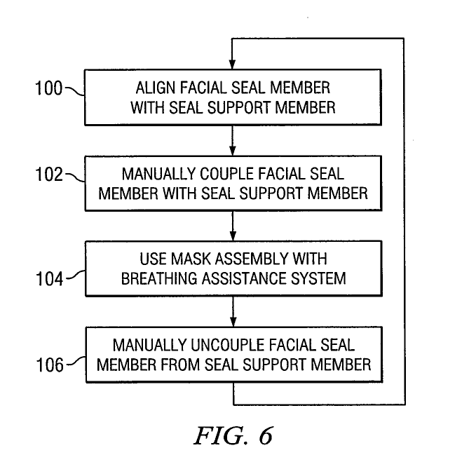

FIG. 6 illustrates a method for coupling and uncoupling facial seal 30 and seal support 32 of patient interface assembly 22, according to certain embodiments. At step 100, with facial seal 30 uncoupled from seal support 32, a user (e.g., patient 11 or other person) may grasp facial seal 30 and seal support 32 such that facial seal connection portion 56 and support member connection portion 42 are aligned. In particular, the user may align protrusion 62 with slot 60.

At step 102, the user may insert protrusion 62 into slot 60 to couple facial seal 30 with seal support 32. For example, the user may insert protrusion 62 into slot 60 at a particular location around the perimeter of slot 60, and work around the perimeter until the complete perimeter (or all portions) of protrusion 62 is worked into slot 60. Working protrusion 62 into slot 60 may include deforming facial seal connection portion 56, which is formed from a deformable material as discussed above. In some embodiments (e.g., the embodiments shown in FIGS. 2 and 4 including an L-shaped protrusion and slot), as the user works around the perimeter of protrusion 62/slot 60, the seal between couple facial seal 30 with seal support 32 becomes tighter and/or more leak-resistant. In some embodiments, facial seal connection portion 56 and support member connection portion 42 are configured such that a user may couple facial seal 30 with seal support 32 relatively quickly and easily by hand. In other embodiments, a tool may be used for connecting facial seal connection portion 56 with support member connection portion 42.

At step 104, with patient interface assembly 22 assembled, mask assembly 14 may be used with breathing assistance system 10 to provide breathing assistance to patient 11. The connection between facial seal 30 with seal support 32 may be sufficient to hold facial seal 30 and seal support 32 together during normal movements by patient 11, e.g., movements of patient 11 during a sleep period.

At step 106, the user may uncouple facial seal 30 from seal support 32, e.g., to clean or replace facial seal 30 and/or seal support 32. To uncouple facial seal 30 from seal support 32, the user may physically pull facial seal 30 and seal support 32 apart until protrusion 62 is freed from slot 60. In some embodiments, the user may work protrusion 62 out from slot 60 at a particular location around the perimeter of slot 60, and then work around the perimeter until the complete perimeter (or all portions) of protrusion 62 are removed from slot 60. In some embodiments, facial seal connection portion 56 and support member connection portion 42 are configured such that a user may uncouple facial seal 30 with seal support 32 relatively quickly by hand. In other embodiments, a tool may be used for disconnecting facial seal connection portion 56 from support member connection portion 42.

The user may repeatedly couple and uncouple facial seal 30 and seal support 32 as desired, as described above at steps 100-106.

It will be appreciated that while the disclosure is particularly described in the context of breathing assistance systems, the apparatuses, techniques, and methods disclosed herein may be similarly applied in other contexts. Additionally, it should be understood that various changes, substitutions and alterations can be made herein without departing from the spirit and scope of the disclosure as illustrated by the following claims.

What is claimed:

1. A patient interface for a breathing assistance system, comprising:
a seal support including a seal support opening and a first connection portion extending at least substantially around the seal support opening; and
a facial seal including:
a first side having a first seal opening, the first side being configured to provide a seal against a patient's face;
a second side having a second seal opening;
a second connection portion extending at least substantially around the second seal opening, the second connection portion being formed from one or more deformable materials such that the second connection portion may be deformed to mate with the first connection portion to releasably couple the facial seal to the seal support and to form a seal between the facial seal and the seal support; and
a passageway extending between the first seal opening and the second seal opening for delivering breathing gas to the patient.

2. A patient interface according to claim 1, wherein:
the second connection portion includes one or more flanges that define a slot; and
the one or more flanges may by deformed to allow the first connection portion to be received into the slot to couple the facial seal to the seal support and to form a seal between the facial seal and the seal support.

3. A patient interface according to claim 1, wherein:
the first connection portion includes one or more flanges that define a slot; and
the second connection portion may by deformed to be inserted into the slot to couple the facial seal to the seal support and to form a seal between the facial seal and the seal support.

4. A patient interface according to claim 1, wherein the facial seal is formed from a first material that is substantially deformable, and the seal support is formed from a second material that is more rigid than the first material.

5. A patient interface according to claim 1, wherein:
the first connection portion extends completely around the seal support opening; and
the second connection portion extends completely around the second seal opening.

6. A patient interface according to claim 1, wherein:
one of the first connection portion and the second connection portion comprises a protrusion having a rounded cross-section; and
the other one of the first connection portion and the second connection portion defines a slot configured to receive the rounded protrusion.

7. A patient interface according to claim 1, wherein:
one of the first connection portion and the second connection portion comprises a protrusion having a substantially L-shaped cross-section; and
the other one of the first connection portion and the second connection portion defines a slot configured to receive the L-shaped protrusion.

8. A patient interface according to claim 7, wherein the protrusion includes:
a first member extending generally in a first direction from the first seal opening to the second seal opening; and
a second member coupled to the first member and extending generally in a second direction substantially perpendicular to the first direction.

9. A patient interface according to claim 8, wherein:
the first member defines a circumference; and
the second member extends outwardly from the circumference defined by the first member.

10. A patient interface according to claim 1, wherein at least one of the first seal opening and the second seal opening has a substantially triangular shape.

11. A patient interface according to claim 1, wherein the facial seal and the seal support may be repeatedly coupled and uncoupled by hand.

12. A facial seal for a breathing assistance system, comprising:
a first side having a first seal opening, the first side being configured to provide a seal against a patient's face;
a second side having a second seal opening;
a first connection portion extending at least substantially around the second seal opening and configured to be releasably coupled to a seal support having a second connection portion, the first connection portion being formed from one or more deformable materials such that the first connection portion may be deformed to mate with the second connection portion of the seal support to releasably couple the facial seal to the seal support and to form a seal between the facial seal and the seal support; and
a passageway extending between the first seal opening and the second seal opening for delivering breathing gas to the patient.

13. A patient interface according to claim 12, wherein:
the first connection portion includes one or more flanges that define a slot; and
the one or more flanges may by deformed to receive the second connection portion of the seal support into the slot to couple the facial seal to the seal support.

14. A patient interface according to claim 12, wherein the first connection portion includes a protrusion that may by deformed to be inserted into a slot defined by the second connection portion of the seal support to couple the facial seal to the seal support.

15. A patient interface according to claim 14, wherein the protrusion has a rounded cross-section.

16. A patient interface according to claim 14, wherein the protrusion has an L-shaped cross-section configured to be received into an L-shaped slot defined by the second connection portion of the seal support.

17. A patient interface according to claim 14, wherein the protrusion includes:
a first member extending generally in a first direction from the second seal opening to the first seal opening; and
a second member coupled to the first member and extending generally in a second direction substantially perpendicular to the first direction.

18. A patient interface according to claim 17, wherein:
the first member defines a circumference; and
the second member extends outwardly from the circumference defined by the first member.

19. A patient interface according to claim 12, wherein the facial seal may be repeatedly coupled to and uncoupled from the seal support by hand.

20. A mask apparatus for delivering gas to a patient, comprising:
a gas delivery conduit for delivering breathing gas toward a patient;
a seal support coupled to the gas delivery conduit and including a seal support opening and a first connection portion extending at least substantially around the seal support opening; and
a facial seal including:
a first side having a first seal opening, the first side being configured to provide a seal against the patient's face;
a second side having a second seal opening;
a second connection portion extending at least substantially around the second seal opening, the second connection portion being formed from one or more deformable materials such that the second connection portion may be deformed to mate with the first connection portion to releasably couple the facial seal to the seal support and to form a seal between the facial seal and the seal support; and
a passageway extending between the first seal opening and the second seal opening for delivering the breathing gas to the patient; and
headgear for securing the facial seal against the patient's face.

21. A patient interface for a breathing assistance system, comprising:
a seal supporting means including a seal supporting means opening and a first connection portion extending at least substantially around the seal supporting means opening; and
a facial sealing means including:
a first side having a first seal opening, the first side being configured to provide a seal against a patient's face;
a second side having a second seal opening;
a second connection portion extending at least substantially around the second seal opening, the second connection portion being formed from one or more deformable materials such that the second connection portion may be deformed to mate with the first connection portion to releasably couple the facial sealing means to the seal supporting means and to form a seal between the facial sealing means and the seal supporting means; and
a passageway extending between the first seal opening and the second seal opening for delivering breathing gas to the patient.

22. A method for assembling a patient interface for a breathing assistance system, comprising:
holding a facial seal including a first side having a first seal opening and configured to provide a seal against a patient's face, a second side having a second seal opening, and a deformable first connection portion extending at least substantially around the second seal opening; and
mating the facial seal with a seal support having a seal support opening and second connection portion extending at least substantially around the seal support opening such that the first connection portion is deformed to mate with the second connection portion to releasably couple the facial seal to the seal support and to form a seal between the facial seal and the seal support.
